(19) United States
(12) Patent Application Publication
(10) Pub. No.: US 2024/0038068 A1
(43) Pub. Date: Feb. 1, 2024

(54) VEHICLE SPEED AND LANE ADVISORY TO EFFICIENCTLY NAVIGATE TIMED CONTROL FEATURES

(71) Applicant: FORD GLOBAL TECHNOLOGIES, LLC, Dearborn, MI (US)

(72) Inventors: Mustafa Ridvan Cantas, Bloomfield Hills, MI (US); Gopichandra Surnilla, West Bloomfield, MI (US); Martin Sommer, Aachen (DE)

(21) Appl. No.: 17/875,544

(22) Filed: Jul. 28, 2022

(51) Int. Cl. G08G 1/0967; G08G 1/01; G08G 1/052

(52) U.S. Cl. CPC G08G 1/096775; G08G 1/096725; G08G 1/0125; G08G 1/052

(57) ABSTRACT

A method includes determining a distance remaining from a current vehicle location to a traffic control signal and determining a recommended speed over the distance remaining that will cause the vehicle to reach the traffic control signal at a time when the signal permits travel. The method includes obtaining traffic data indicating the presence of traffic between the present location and the signal and predicting movement patterns and timing of traffic indicated by the traffic data, and adjusting the recommended speed to accommodate the predicted movement patterns and timing of traffic, to preserve vehicle momentum in light of changes to travel required by the predicted movement patterns and timing. The method additionally includes displaying the recommended speed and continuing at least the determining the distance, determining the recommended speed and displaying the recommended speed until the vehicle either stops or reaches the traffic control signal.

### TECHNICAL FIELD

The illustrative embodiments generally relate to methods and apparatuses for vehicle speed and lane advisories to efficiently navigate timed control features.

### BACKGROUND

At certain times of day for some traffic lights, and consistently for other traffic lights, light timing is controlled by certain variables, which, if known and accommodated, could allow a driver who could maintain a consistent speed to travel unimpeded through a sequence of lights. In some instances, however, the timing is a function of cross-traffic, and even if a driver could see a vehicle waiting for a cross-light, it may be a near impossibility to predict when the light would change based on the presence of another vehicle. In other instances, the light timing is consistently cyclical, but until a driver gets onto a known cycle, at least one light may have to be accommodated.

Even drivers who learn local timing of lights, to, for example, drive a consistent speed once a first light turns green, in order to correctly time other lights, have no real way to determine traffic ahead, which may cause the driver to have to slow and miss a light cycle. Further, in a multi-lane road, the driver may not know which lane was the most clear, until it was too late to change lanes, also causing the driver to slow and miss-time a light.

Being able to slow, but not stop, and consistently maintain speeds, provides reasonable increases in fuel efficiency, reduced travel time, and a more comfortable ride. Problematically, however, there are many dynamic variables in play that are not easily managed by a driver who is attempting to navigate a sequence of timed lights to circumvent a stop. Accordingly, unless the driver is alone or in very limited traffic, the driver's attempts at such navigation will almost always be unsuccessful, and attempts to accommodate changing variables, such as unexpected traffic between lights, may cause the driver to have to drive in a somewhat erratic manner, to accommodate lost time and last-second lane changes necessary to maintain a certain speed.

### SUMMARY

In a first illustrative embodiment, a system includes one or more processors configured to determine the presence of a state-changing traffic control signal within a predefined distance from a first vehicle. The one or more processors are also configured to request timing information of the traffic control signal. Also, the one or more processors are configured to determine a recommended vehicle speed from a present location to the traffic control signal that will cause the first vehicle to reach the control signal while preserving vehicle momentum, at a time when the control signal will permit travel, based on the timing information and display the recommended speed on a vehicle display of the first vehicle.

In a second illustrative embodiment, a method includes determining a distance remaining from a current location of a vehicle to a traffic control signal and determining a recommended speed over the distance remaining that will cause the vehicle to reach the traffic control signal at a time when the signal permits travel, based on state change timing information associated with the traffic control signal. The method also includes displaying the recommended speed and continuing the determining the distance, determining the recommended speed and displaying the recommended speed until the vehicle either stops or reaches the traffic control signal, to accommodate for speeds of the vehicle not matching the recommended speed.

In a third illustrative embodiment, a method includes determining a distance remaining from a current location of a vehicle to a traffic control signal. The method also includes determining a recommended speed over the distance remaining that will cause the vehicle to reach the traffic control signal at a time when the signal permits travel, based on state change timing information associated with the traffic control signal. The method further includes obtaining traffic data indicating the presence of traffic between the present location and the signal and predicting movement patterns and timing of traffic indicated by the traffic data. Also, the method includes adjusting the recommended speed to accommodate the predicted movement patterns and timing of traffic, to preserve vehicle momentum in light of changes to travel required by the predicted movement patterns and timing. The method additionally includes displaying the recommended speed and continuing at least the determining the distance, determining the recommended speed and displaying the recommended speed until the vehicle either stops or reaches the traffic control signal, to accommodate for speeds of the vehicle not matching the recommended speed.

### BRIEF DESCRIPTION OF THE DRAWINGS

FIG. 1 shows an illustrative example of a vehicle and an intersection system;

FIG. 2 shows an illustrative example of a timing and speed prediction process;

FIG. 3 shows and illustrative traffic-accommodation process;

FIG. 4 shows an illustrative example of a data-flow for timing and speed recommendations; and

FIG. 5 shows an illustrative scenario where lane and speed controls may be used.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments, particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

Execution of processes may be facilitated through use of one or more processors working alone or in conjunction with each other and executing instructions stored on various non-transitory storage media, such as, but not limited to, flash memory, programmable memory, hard disk drives, etc. Communication between systems and processes may include use of, for example, Bluetooth, Wi-Fi, cellular communication and other suitable wireless and wired communication.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

With respect to the illustrative embodiments described in the figures showing illustrative process flows, it is noted that a general purpose processor may be temporarily enabled as a special purpose processor for the purpose of executing some or all of the exemplary methods shown by these figures. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

It is always a very satisfying experience to encounter a string of green lights when traveling, permitting continuous travel with limited to no stopping. Some drivers occasionally accomplish this incidentally, others may have some general familiarity with light timing and will know how fast they have to drive, unimpeded, to reach the next light during a green cycle. Unfortunately, unexpected variables, such as traffic, can often ruin such plans between lights. A driver who knows they have to travel 50 mph between lights may find that other traffic is passing them, and they may know that the other traffic will eventually have to stop, but that it will also create an impediment to unimpeded travel.

The driver may not know what lane the other traffic will ultimately stop in, which can cause the driver to continually have to change lanes and attempt to predict which lane will be the most clear. If vehicles had better information about light timing and traffic situations, the other drivers would have limited to no incentive to speed ahead, as doing so would only guarantee they would have to stop at a red light. Drivers working with better information can drive in a more coordinated manner and all drivers could benefit from limited slowdowns. This would reduce congestion, increase fuel efficiency, smooth rides (reduce jerkiness and sway) and generally keep an overall traffic system flowing better while preserving fuel resources.

The illustrative embodiments propose a system that can utilize multiple information sources, such as, but not limited, to vehicle to vehicle (V2V) communication, vehicle to infrastructure communication (V2I), vehicle sensors, infrastructure sensors, cameras, and other vehicle information to better predict traffic flow, optimal speeds and optimal lanes to keep vehicles moving. Knowing how many vehicles and/or what types of vehicles are already stopped, or are projected to have to stop, at a given light and/or in a given lane, can help make predictions about how long before all traffic is moving once the light turns green. While a given driver's speed change profile may not be known, general assumptions about vehicle speed changes can be used. The presence of certain vehicles may be reported if those vehicles are connected vehicles, and cameras and vehicle sensors can be used to model the presence of vehicles which cannot or do not self-report.

Timing information of lights may be available from a general database about lights, if the light timing is consistent and cyclical. This information can be obtained directly from light providers (e.g., municipalities), or may be obtained through historic observation using vehicle sensors (e.g., speed, camera, etc.). Timing information for dynamically timed lights, such as those that react to other traffic, can be distributed via infrastructure transceivers and/or modeled based on observed behavior of the given traffic light.

For example, in one instance, a light may inform the infrastructure when it will change state, and vehicles can use this information to plan optimal speeds to reach the light when it is green, with minimal slowdown to preserve speed and fuel. In another instance, a vehicle passing a light may observe stopped cross traffic, which may give some information that a light state change may occur, based on historic knowledge of how that light behaves. Trailing vehicles can attempt to use this information to time the light change, although it may be difficult to model this change with precise accuracy, unless one knows how long the stopped vehicle has been stopped, assuming the light reacts to the presence of a stopped vehicle with some form of consistency. Nonetheless, better information flow and analysis can result in shorter travel times, reduced slowdowns, smoother vehicle rides and better fuel efficiency.

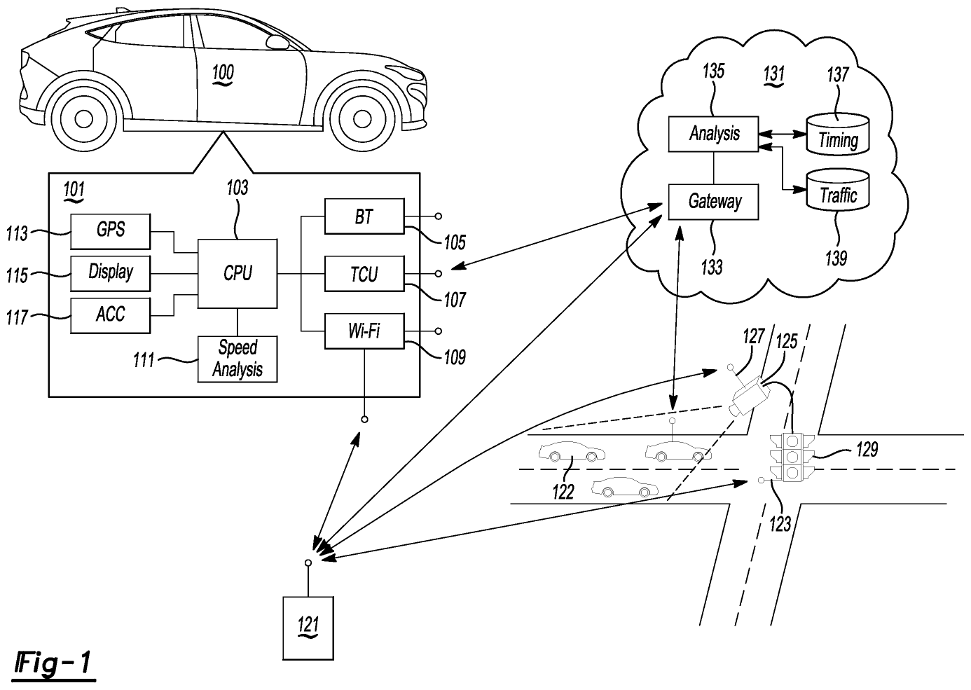

FIG. 1 shows an illustrative example of a vehicle and an intersection system. In this example, vehicle 100 is called the ego-vehicle, and is the centric point for which determinations are made in the examples. This vehicle 100 includes an onboard computing system 1010, which includes one or more processors 103, as well as communication transceivers. Those can include, for example, BLUETOOTH 105, a telematics control unit (TCU) 107 providing long range cellular communication, and a Wi-Fi transceiver 109. The Wi-Fi transceiver can be used to communicate with infrastructure and other vehicles. The BLUETOOTH transceiver can be used to communicate with an onboard device, such as a cellular phone, and other vehicles at close range. The TCU can be used for long range cellular communication and can allow the vehicle 100 to access databases and information sources about traffic, light timing, etc.

The vehicle 100 may also include a speed and land analysis process 111. A similar process 135 may execute in the cloud 131. Whether speed and lane recommendations are made onboard or in the cloud can be a matter of design choice. Both systems may also work in conjunction, with the cloud 131 process 135 making longer-term recommendations and the onboard process 111 making short-term recommendations adapting to changing information as the vehicle 100 approaches a light 129.

The vehicle 100 may include a navigation system and coordinate system such as a global positioning system 113, which can be useful to determine proximity to lights and self-report location information to assist other vehicles 122 in making travel speed determinations. The vehicle 100 may further include a display 115 for providing, among other things, lane usage and speed recommendations. Speed recommendations can be dynamically adaptive to changing situations, and may attempt to help the driver manage a speed to preserve fuel and momentum as much as possible. If the vehicle is fully autonomous, or partially autonomous (with, for example, and adaptive cruise control process 117), the vehicle 100 may be able to benefit from timing and lane information to assist a driver or control the vehicle to maintain speeds and/or lanes in accordance with recommendations.

General infrastructure may include one or more transceivers 121, such as Wi-Fi or other transceivers capable of communication with vehicles and with traffic control features 129. Communication with vehicles out of range of a traffic control cameras 125 may assist a camera timing system in making decisions based on vehicle locations. For example, a light may historically change when a vehicle has been stopped for more than 15 seconds. A busy road my have the primary green lights, but the light may change to accommodate cross traffic when present. If the light had knowledge that such a vehicle was approaching, and that no cross traffic on the main road were present when the approaching vehicle was predicted to arrive, the light could time a change to allow the crossing vehicle to pass without stopping, which would increase traffic flow for that vehicle and which could circumvent a state change of the light at a later time when traffic was present on the main road. Infrastructure transceivers 121 could receive this information transmitted from a light system transceiver 123, 127 and could also share this timing change information with the cloud 131, where it could be made broadly available as part of a temporary timing change in a timing database 137. Vehicles approaching the intersection would then know to slow down, so that they did not reach the intersection while the state change was still underway.

The cloud 131 may include a number of backend processes and be capable of handling a variety of communication and service requests through a gateway 133. The gateway can route requests for light timing, speed and lane suggestions, etc. to an analysis process 135. That process could have access to timing databases 137, which may store known light timing schedules, historical analysis of light timing, and temporary changes to timing such as that above, or, for example, to accommodate emergency vehicles. The cloud 139 may also have access to traffic data 139, which can include presently reported (self-reported and/or detected) vehicle locations, which may be useful for determining traffic already-stopped or about-to-stop at a given light. This location information may also be accessible to the light infrastructure transceivers 121, which can use the information for dynamic timing changes. Historic traffic information may be useful when present data is not currently known, such as information indicating that an average of 2.5 vehicles are stopped at a given light between 5 and 7 PM, and so any speed predictions may want to accommodate the likelihood of intervening stopped traffic that has to get underway.

As an ego-vehicle approaches a light, it can use sensing to determine if lanes are occupied or clear, and determine the accuracy of speeds based on predicted traffic. If a lane that was expected to have vehicles appears clear, for example, and if there are no adjacent traveling vehicles that may move into that lane, then the ego-vehicle speed may be increased or a recommendation for increase may occur, as well as recommendation for shifting to the open lane. This can be an example of cloud modeling predicting a traffic situation initially and the onboard analysis process adapting to accommodate the real-time situation as the ego-vehicle approaches the light. Depending on the robustness of sensor feedback from infrastructure, such as cameras 125, additional information about a traffic situation at a light may become available as the ego-vehicle approaches the light and comes within range of an infrastructure transceiver or another vehicle 122 stopped at the light that can use its own onboard sensors to analyze and report the situation to the approaching ego-vehicle, over Wi-Fi, for example.

At the same time, such infrastructure transceivers and stopped vehicles could also be reporting to the cloud 131, so with a robust overall system there can be a reasonably complete conveyance and update of information about the immediate scene at any given light at most times.

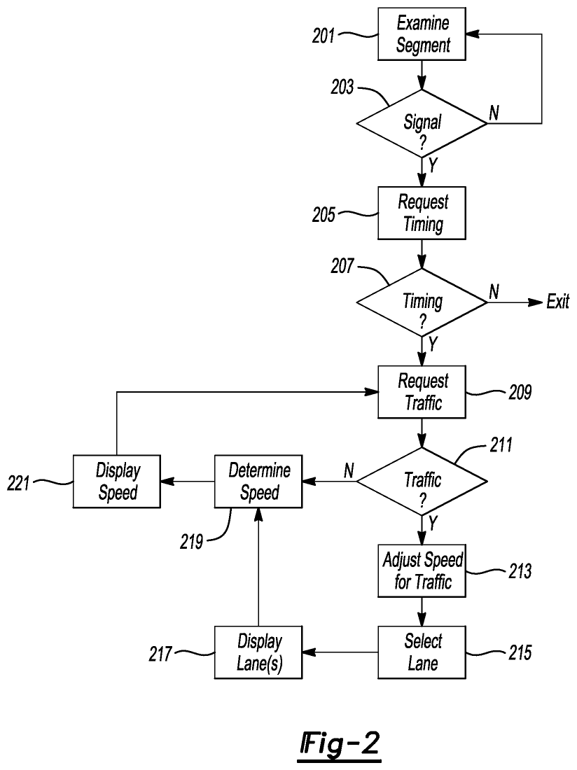

FIG. 2 shows an illustrative example of a timing and speed prediction process. In this process, a route analysis engine examines an upcoming segment of road at 201, which can include a predefined distance, a distance until a next known traffic control, a distance over which no traffic controls until a next traffic control is expected, etc.

For example, if a user is traveling 10 miles on a single road until a next traffic control, it probably does not make a lot of sense to try to plan speeds, unless the traffic control executes in 10 minute cycles, for example. That is, long before the user reaches the control, the state will have changed a number of times regardless of user speed. Accordingly, the process may examine a maximum distance ahead, which can relate to the speed of a vehicle, duration of travel to a control vs. duration of a cycle for the same control (e.g., begin examining the control when a vehicle is within N cycles of control, in terms of travel time). For example, if a light was on a 1 minute state change interval in each direction, the process may begin examining the light when the user was 2-4 minutes away, to build a traffic profile and predict timing. That also assumes there are no intervening controls.

If, for example, there was a stop sign prior to reaching the control, the user would have to stop in any event, so in that instance the process may begin examining the light once the user had cleared the stop sign. In this manner, and similar manners, the size and distance of a segment of upcoming road can be dynamically adapted to when it is reasonable to begin planning travel to reach a light in a favorable cycle point.

If there is a signal within the distance examined at 203, the process may request timing information for the light at 205. This can include information such as known timing, a current point in cycle, etc. If the information comes directly from the light or a light control system, the process may obtain timing information that is precise for a current state and indicates when a next state will occur. If the information is from a database, the information may only include state durations, if known, and/or historical data indicating likely timing if the timing is not occurring and known and confirmed intervals. The request may be sent to a infrastructure unit 121 in communication with a light 129 or light control system, or to the cloud 131, or both. If ad hoc networking is available through V2V communication, the request may also be sent forward to sufficient vehicles until one vehicle with sensing capability (e.g., a camera) can see the current light state.

Even if the information is somewhat incomplete, knowing the current state and the cycle duration can assist in predicting a change. If there is no timing information available, the process may exit. The process may also obtain some information based on self-observation, for example, if the vehicle frequently travels a route, and the vehicle 100 itself can keep a record of light cycle timings for commonly observed lights at different times of day, observed based on when the vehicle 100 is forced to stop and permitted to go.

The vehicle 100 or process may also request traffic information at 209, which again can be a request to the infrastructure 121, to other vehicles 122, to the cloud 131, etc. Different sources of information may be combined to build a more complete picture of the scene, in terms of both vehicles presently stopped at the light and vehicles traveling to the light.

If no traffic information is available or if traffic is not present, to the knowledge of the process, at 211, the process can determine an appropriate speed at 219. This is a speed designed to optimize or partially optimize fuel efficiency by preventing having the vehicle change speed too quickly or stop unnecessarily. The vehicle may have to decrease speed some, but this may be preferable to maintaining a faster speed and then being forced to fully stop and then fully reaccelerate. The recommended speed can be displayed at 221, which can be a number that fluctuates if the user is not precisely mapping the speed, so that the user continually knows what speed, from a present location, is recommended to optimize fuel efficiency and travel smoothness from that moment in time. For example, the speed may be 40 MPH recommended, but the user may continue to travel at 50 MPH. This will likely cause the recommended speed to drop as the user approaches the light, and so the speed recommendation may lower to 30 MPH, to prevent a full stop. Users may also be able to engage autonomous or semi-autonomous (such as cruise control or adaptive cruise control) settings to maintain a recommended speed and which may also be capable of reacting to traffic that may appear, from adjacent roads or onramps, for example.

If traffic data is known or obtained at 211, the process may make accommodation for traffic at 213. This can include determining likely start and movement profiles for each vehicle already stopped, as well as estimating speed profiles for moving vehicles that will likely stop prior to the ego vehicle reaching the light. Lane positions can also be accommodated, so that a movement profile for each lane can be built. Using the example above, the same recommendation to travel at 40 MPH when there was no traffic may be 20 MPH for lane 1 when there is traffic and 25 MPH for lane 2. This could be because more vehicles are stopped in lane 1, and will take longer to begin travel, or, for example, because the vehicles or a vehicle in lane 1, such as a large truck, may take longer to begin moving.

Even if a comparable number of vehicles are in each lane, some vehicles, such as those approaching the light, may not fully have to stop if their present speeds and locations will allow them to reach the light with some momentum preserved. The process may build a projected travel and speed profile for each vehicle in a lane and aggregate the information to determine a location where the ego vehicle will reach based on certain speeds (without encountering a non-moving other vehicle) and what speeds will allow the ego vehicle to preserve momentum. That is, while the user could maintain the 40 MPH speed and some traffic may have begun moving by that time, the user will likely have to stop because not all traffic will have moved, and the user will reach a stopping point closer than the intersection itself, before all traffic moves, that stopping point being the point behind the closest vehicle to the ego vehicle in a given lane. This shortens the distance of travel as well as requires a lower speed because of delays in movement, and both may be accommodated by the calculations.

The process may select a lane that has the greatest likelihood of fuel preservation at 215 and recommend that lane to the driver at 217. At this point, since the profiles for the lanes are known, the process can also display the recommended speed for that lane and/or any other lanes as appropriate. The process may also calculate a gradual transition of speed when possible, to prevent a user braking hard to drop from 50 to 30 MPH, and so may recommend a step down to certain speeds which may ultimately reach a target speed but which may prevent hard braking.

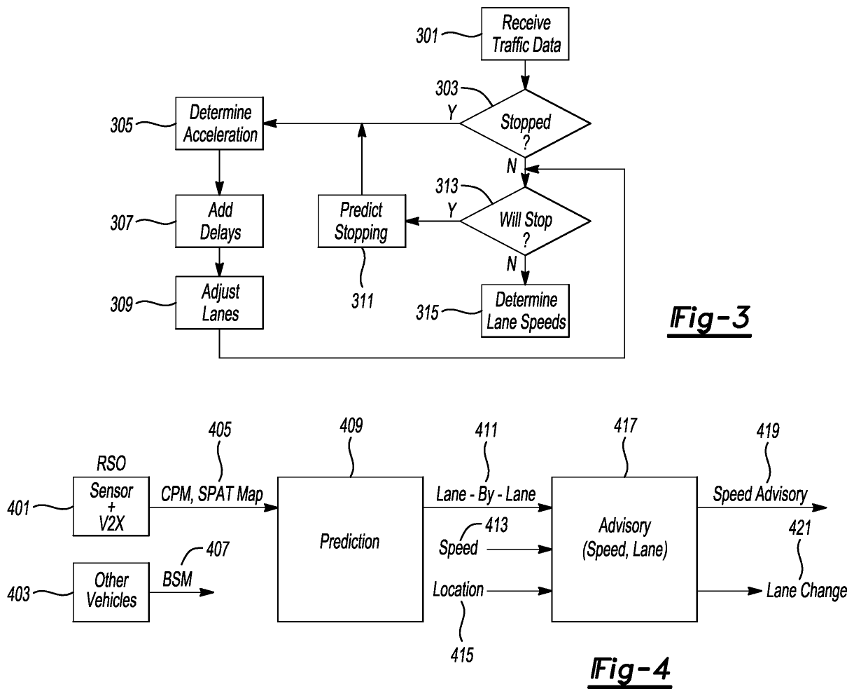

FIG. 3 shows and illustrative traffic-accommodation process. In this example, the process may receive traffic data 301 that includes data sent from intersection cameras 125 and/or transceivers 121, indicating the presence of stopped vehicles 122 at a light or vehicles between an ego vehicle and the signal. The data may also be received from the cloud, and represent vehicles reporting their own locations and movement profiles to the cloud, which are also intervening between the ego vehicle and the signal. The data may further be received via V2V communication, and can include both responding vehicle data for travel data of responding vehicles as well as sensor data indicating detected other vehicles that may not currently be reporting information.

For a given vehicle indicated in the traffic data, the process may determine if the vehicle is presently stopped at 303. For each stopped vehicle, the process may determine a projected speed increase rate at 305, which can include, for example, how long a vehicle of a certain size historically tends to take to increase speed once a signal changes. This may also include a longer delay based on how far back in a line of stopped vehicles each vehicle is, since traffic does not always move in unison based on a signal change. Each vehicle will not typically move forward until the vehicle leading it begins to move, so traffic often moves in a ripple as a light changes. Also, heavier and larger vehicles often take longer to achieve momentum, and observed vehicle size can be useful in making at least an average determination.

The process may then add in delays for each line of vehicles at 307, and adjust each lane accordingly at 309. Not only does a line of stopped vehicles take some amount of time to move, but it also moves a possible stopping point back closer to the ego vehicle, so the process may accommodate for this as well. For example, the process may determine, for a given ego speed, where a likely stopping point will be if all of the leading vehicles have begun movement, but have not achieved full speed, the timing of a recommended speed can be designed to reach a point where the maximum speed can be preserved without a likely encounter with another vehicle—e.g., a point where, for example, at least 20 MPH can be preserved assuming all leading vehicles move predictably, even if 40 MPH would be an optimal speed were there no leading vehicles. But this may be preferable to recommending 25 MPH, for example, which may cause the ego vehicle to have to slow to 10 MPH or even stop, because of the movement profiles of the leading vehicles.

The process may further consider any vehicles in the traffic data that are still moving but which, based on their present locations and/or speed, will likely have to stop at some point. The predicted stopping points of those vehicles can also be accommodated and their movement profiles from those stopping points back to some level of speed can be accounted for.

Based on the lane adjustments for each lane in light of the traffic data, the process can determine likely lane speeds once a light changes and at a given time for a given location along the lane—e.g., at time X, lane 1 will have reached a speed of 10 MPH for the slowest (last leading) vehicle and that last vehicle will be at location N. Thus, if the ego vehicle is predicted to also be at or past location N at that moment in time, a slower speed will be recommended. If the ego vehicle will reach point N at some point after this moment in time, a higher speed can be recommended, until the ego speed recommendation places the ego vehicle at a maximum speed that will prevent encounter with another vehicle but that preserves as much momentum as possible and places the ego vehicle as close to the light as possible, within a timing cycle. If a stop is predicted to be unavoidable, based on a volume of traffic, this information can be conveyed as well, and a fuel preserving speed in light of the predicted necessary stop can be recommended. Using this lane-level data, an optimal predicted lane can be derived and recommended, such as coasting as much as possible without intentional speed changes in light of the fact that the vehicle 100 may not be able to prevent a stop.

Again, as noted before, autonomous control can follow the recommendations and/or can be requested by a driver, if not always engaged, in order to have the vehicle 100 more accurately follow the target speeds and achieve an smoother speed change profile to preserve fuel.

FIG. 4 shows an illustrative example of a data-flow for timing and speed recommendations. In this example, a road-side unit (RSU) 401 provides sensor data and V2I communication data, indicating observed vehicles, their speeds and locations, as well as any reported vehicle's (self-reporting) speeds and locations. The unit may also receive indications of autonomous control, usable to determine how likely a given vehicle 122 is to follow a machine-oriented trajectory, which may be more predictable than a human-controlled trajectory.

Remote vehicles 403 may report basic messages 407, which may include locations and speeds. The RSU 401 may include collaborative perception messaging (CPM), which may be the BSMs of each detected vehicle, as well as light signal phase and timing information (SPAT) for an upcoming control feature, and map data indicating lanes, and a layout of an intersection 405. This map data may be useful if certain lanes are turn-only lanes and should not be recommended as a “fast” passthrough lane, even if empty of traffic, because a driver would then be forced to turn.

A prediction process such as that discussed in FIGS. 3 and 4 can receive the above information and determine a traffic movement preview for each lane 411. That information, along with ego vehicle speed 413 and location 415 can be used to generate an advisory route 417. This may include, for example, speed limit advisories (what speed the vehicle should be traveling to preserve fuel/momentum) at 419 and/or any lane change advisories 421, if the vehicle 100 is not in an optimal lane.

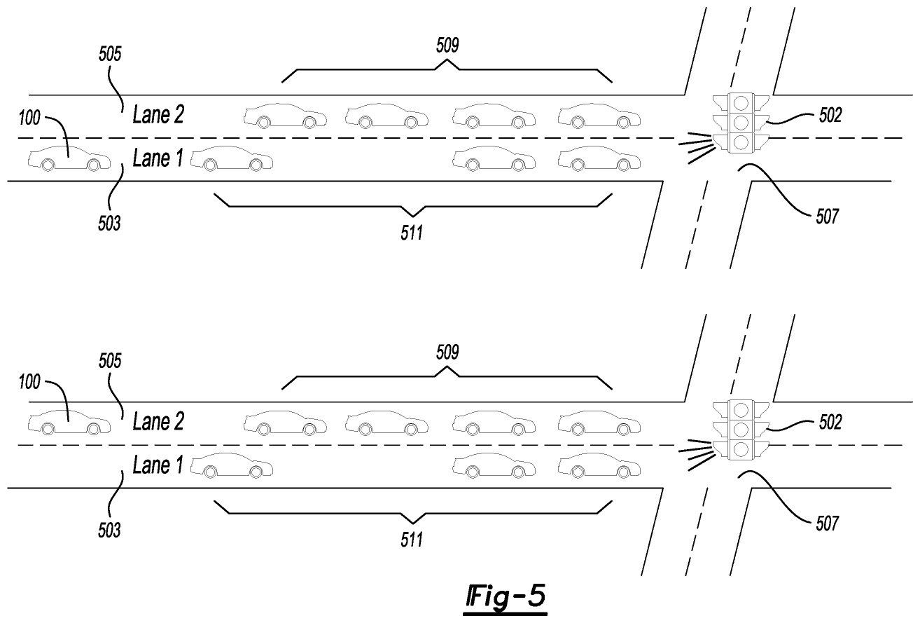

FIG. 5 shows an illustrative scenario where lane and speed controls may be used. In this example, vehicle 100 is shown in two locations, once in lane 1 503 and once in lane 2 505. The traffic 509 in lane 2 is already stopped at intersection 507, and includes four vehicles. The traffic 511 in lane 1 is partially stopped and includes one still-traveling vehicle. Even if the still traveling vehicle is forced to stop, there is likely less full travel time for all traffic in lane 1 to achieve some level of forward movement, however tailgating the last vehicle at certain speeds may force the ego vehicle to stop. Lane 1 will likely be recommended as the preferable lane, but at a speed which accommodates any prediction that the trailing vehicle in lane 1 will be required to stop at some point. Signal timing information for the light 502 will be useful to determine when the light will change to a permissible state, and the recommended speed of the ego-vehicle 100 can be adjusted accordingly.

If a large vehicle was parked in lane 1, such as a semi-truck, then lane 2 might be a faster lane, even with more traffic, because of the delay in movement for such large vehicles once stopped. If the last intervening vehicle in the traffic 511 in lane 1 was the semi, whether lane 1 or lane 2 was recommended might be based on whether or not the semi was predicted to have to stop, based on its own present location and observed speeds. It is virtually impossible for a driver to account for all this information and make such projections, especially when precise light timing is rarely, if ever, known, and so the illustrative embodiments provide recommendations that produce a high likelihood of success, prevent erratic travel, and generally assist in preserving fuel and reducing overall travel time and traffic congestion. If many intervening vehicles using such systems never have to come to a full stop, overall traffic flow can increase significantly because there will be fewer delays between light cycles as vehicles have to wait not only for a cycle to change, but for all intervening vehicles to begin moving.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A system comprising:
one or more processors configured to:
determine the presence of a state-changing traffic control signal within a predefined distance from a first vehicle;
request timing information of the traffic control signal;
determine a recommended vehicle speed from a present location to the traffic control signal that will cause the first vehicle to reach the control signal while preserving vehicle momentum, at a time when the control signal will permit travel, based on the timing information; and
display the recommended speed on a vehicle display of the first vehicle.

2. The system of claim 1, wherein the timing information includes state durations or state change intervals for the signal.

3. The system of claim 1, wherein the timing information includes a current state and either a duration of the current state or a time until a next state of the signal.

4. The system of claim 1, wherein the determination of recommended vehicle speed continues as the vehicle travels to the signal and adjusts to actual vehicle speed, and wherein the displayed recommended vehicle speed changes to reflect the continued determination.

5. The system of claim 1, wherein the one or more processors are further configured to:
receive a request to control the first vehicle at the recommended speed; and
automatically maintain the recommended speed until the first vehicle reaches the signal, barring occurrence of a sensor event that causes the first vehicle to fall below the recommended speed.

6. The system of claim 1, wherein the one or more processors are further configured to:
request traffic data indicating the presence of traffic between the present location and the signal;
predict movement patterns and timing of traffic indicated by the traffic data; and
adjust the recommended speed to accommodate the predicted movement patterns and timing of traffic, to preserve vehicle momentum in light of changes to travel required by the predicted movement patterns and timing.

7. The system of claim 6, wherein the predicted movement patterns include predicting whether a given vehicle included in the traffic data will have to stop as a result of a state of other traffic or the signal.

8. The system of claim 6, wherein the predicted movement patterns include predicting travel speeds of one or more vehicles included in the traffic data until the first vehicle reaches the signal.

9. A method comprising:
determining a distance remaining from a current location of a vehicle to a traffic control signal;
determining a recommended speed over the distance remaining that will cause the vehicle to reach the traffic control signal at a time when the signal permits travel, based on state change timing information associated with the traffic control signal, wherein the recommended speed is chosen to achieve at least one of maximum projected fuel efficiency or minimal braking while still causing the vehicle to reach the traffic control signal at the time when the signal permits travel;
displaying the recommended speed; and
continuing the determining the distance, determining the recommended speed and displaying the recommended speed until the vehicle either stops or reaches the traffic control signal, to accommodate for speeds of the vehicle not matching the recommended speed.

10-11. (canceled)

12. The method of claim 9, further comprising:
receiving a request for automatic control of the vehicle; and
automatically controlling the vehicle to operate at the recommended speed.

13. The method of claim 9, further comprising:
obtaining traffic data indicating the presence of traffic between the present location and the signal;
predicting movement patterns and timing of traffic indicated by the traffic data; and
adjusting the recommended speed to accommodate the predicted movement patterns and timing of traffic, to preserve vehicle momentum in light of changes to travel required by the predicted movement patterns and timing.

14. The method of claim 13, further comprising:
predicting a recommended lane of travel, based on the predicted movement patterns and timing of the traffic, that allows for a maximum recommended speed; and
recommending travel in the predicted recommended lane.

15. The method of claim 13, wherein the predicted movement patterns and timing of the traffic are based at least in part on vehicle size characteristics indicated in the traffic data.

16. A method comprising:
determining a distance remaining from a current location of a vehicle to a traffic control signal;
determining a recommended speed over the distance remaining that will cause the vehicle to reach the traffic control signal at a time when the signal permits travel, based on state change timing information associated with the traffic control signal;
obtaining traffic data indicating the presence of traffic between the present location and the signal;
predicting movement patterns and timing of traffic indicated by the traffic data;
adjusting the recommended speed to accommodate the predicted movement patterns and timing of traffic, to preserve vehicle momentum in light of changes to travel required by the predicted movement patterns and timing;
displaying the recommended speed; and
continuing at least the determining the distance, determining the recommended speed and displaying the recommended speed until the vehicle either stops or reaches the traffic control signal, to accommodate for speeds of the vehicle not matching the recommended speed.

17. The method of claim 16, wherein the recommended speed includes a speed determined to achieve maximum fuel efficiency or a speed determined to achieve minimal braking.

18. The method of claim 16, further comprising:
receiving a request for automatic control of the vehicle; and
automatically controlling the vehicle to operate at the recommended speed.

19. The method of claim 16, further comprising:
predicting a recommended lane of travel, based on the predicted movement patterns and timing of the traffic, that allows for a maximum recommended speed; and
recommending travel in the predicted recommended lane.

20. The method of claim 16, wherein the predicted movement patterns and timing of the traffic are based at least in part on vehicle size characteristics indicated in the traffic data.
